(19) United States
(12) Patent Application Publication
(10) Pub. No.: US 2009/0206181 A1
(43) Pub. Date: Aug. 20, 2009

(54) Fuel Injector

(76) Inventors: Stefan Arndt, Stuttgart (DE); Markus Gesk, Karlsbad (DE); Guenter Dantes, Eberdingen (DE); Joerg Heyse, Besigheim (DE); Andreas Krause, Unterriexingen (DE); Kai Gartung, Stuttgart (DE)

Correspondence Address: KENYON & KENYON LLP, ONE BROADWAY, NEW YORK, NY, 10004, US

(21) Appl. No.: 11/886,833

(22) PCT Filed: Feb. 14, 2006
(86) PCT No.: PCT/EP2006/050925

§ 371 Date: Jan. 14, 2009

(30) Foreign Application Priority Data
Apr. 15, 2005 (DE) 102005017420.5

(51) Int. Cl. F02M 61/04; B05B 1/30

(52) U.S. Cl. 239/533.12; 239/584

(57) ABSTRACT

A fuel injector includes an orifice plate situated downstream from a valve-seat body having a fixed valve seat, the orifice plate having at least one outlet opening. Provided directly upstream from the outlet openings is an inflow opening having an annular inflow cavity. The valve-seat body covers the inflow cavity in such a way that the downstream outlet openings of the orifice plate are covered. The inflow cavity directly upstream from the at least one outlet opening is configured such that the flow approaches the at least one outlet opening largely at a right angle to the longitudinal extension of the outlet opening. With regard to the cross section, the at least one outlet openings has a polygonal form, in particular one that encloses at least one triangle, or it has a meander shape with a plurality of curves in the outer contour. The fuel injector may be particularly suitable for use in fuel injection systems of the mixture-compressing internal combustion engines having external ignition.

### FIELD OF THE INVENTION The present invention relates to a fuel injector.

### BACKGROUND INFORMATION

German Patent No. DE 42 21 185 describes a fuel injector which has an orifice plate with a plurality of outlet openings downstream from a fixed valve seat. By stamping, the orifice plate is first provided with at least one outlet opening, which extends parallel to the longitudinal valve axis. With the aid of deep-drawing, the orifice plate is then plastically deformed in its mid section where the outlet openings are located, so that the outlet openings extend at an incline relative to the longitudinal valve axis and widen frustoconically or conically in the flow direction. This achieves excellent conditioning and good jet stability of the medium discharged through the outlet openings compared to conventional fuel injectors; nevertheless, the manufacturing process of the orifice plate with its outlet openings is very involved. The outlet openings are provided immediately downstream from an exit opening in the valve-seat body and thus are directly exposed to the flow, the outlet openings themselves defining the narrowest cross section of the flow.

U.S. Pat. No. 6,405,946 describes a fuel injector already known in which an orifice plate having a plurality of outlet orifices is provided downstream from the valve seat. An inflow opening, which has a larger diameter and forms an annular inflow cavity for the outlet openings, is formed between an outlet opening in the valve-seat body and the orifice plate. The outlet openings of the orifice plate are in direct flow connection with the inflow orifice and the annular inflow cavity and covered by the upper boundary of the inflow opening. In other words, a complete offset from the exit opening defining the intake of the inflow opening, and the outlet openings is present. Due to the radial offset of the outlet openings relative to the exit opening in the valve-set body, an s-shaped flow characteristic of the fuel results, which constitutes an atomization-promoting measure. The outlet openings have a round or elliptical cross section.

### SUMMARY

A fuel injector according to an example embodiment of the present invention advantageously may provide a uniform and very fine atomization of the fuel in an uncomplicated manner, and that an especially high conditioning and atomization quality with very tiny fuel droplets is obtained. This may be achieved in an advantageous manner in that outlet openings are provided downstream from a valve seat, which are horizontally approached by the flow and contoured in such a way that the circumference of the outlet opening is maximized in relation to the cross section of the outlet opening. The wall of the particular outlet opening at the entry plane does not impede the horizontal velocity components of the flow entering the entry plane, so that the fuel jet, once it leaves the outlet opening, has the full intensity of the horizontal components generated in the inflow cavity and thus fans out with maximum atomization. Due to the horizontal flow exposure of the outlet openings, the flow in the outlet openings is directionally diffuse because of the generated turbulence. The immediate fanning-out prevents that the surface tension of the fluid contracts the emerging jet into a cylindrical jet having a smaller free surface. The enlarged free jet surface area facilitates the further disintegration into smaller droplets.

Upstream from the outlet opening, an inflow opening having an annular inflow cavity is advantageously provided in the valve-seat body, the inflow opening being larger than an outlet opening downstream from the valve seat. In this way the valve-seat body already assumes the function of a flow controller in the orifice plate. In an especially advantageous manner, the design of the inflow opening may achieve an s-deflection in the flow so as to improve the atomization of the fuel since the valve-seat body covers the outlet openings of the orifice plate by the upper boundary of the inflow opening.

Using galvanic metal deposition, it is advantageously possible to produce orifice plates in very large lot numbers simultaneously, in a reproducible and extremely precise as well as inexpensive manner. Furthermore, this production method allows great freedom in the contouring of the outlet openings in the orifice plate.

### BRIEF DESCRIPTION OF THE DRAWINGS

Exemplary embodiments of the present invention are depicted in simplified fashion in the figures and explained in greater detail below.

FIG. 1 shows a partially illustrated fuel injector.

FIG. 2 shows an enlarged view of the cutaway portion II in FIG. 1 having the region configured according to an embodiment of the present invention.

FIG. 3 shows a first exemplary embodiment of an outlet opening.

FIG. 4 shows a second exemplary embodiment of an outlet opening.

FIG. 5 shows a third exemplary embodiment of an outlet opening.

FIG. 6 shows a fourth exemplary embodiment of an outlet opening.

FIG. 7 shows a fifth exemplary embodiment of an outlet opening.

FIG. 8 shows a sixth exemplary embodiment of an outlet opening.

FIG. 9 shows a seventh exemplary embodiment of an outlet opening.

### DETAILED DESCRIPTION OF EXAMPLE EMBODIMENTS

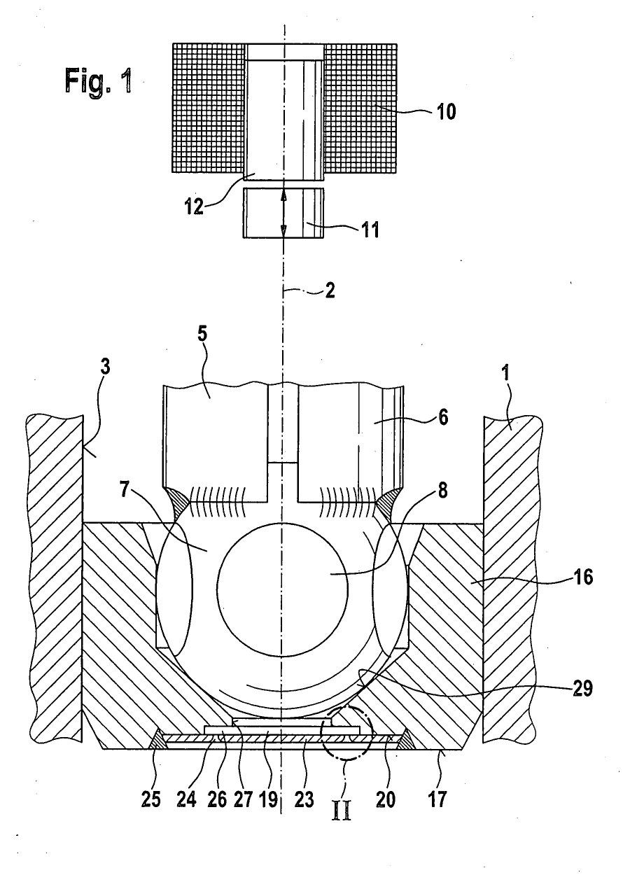

FIG. 1 shows as an exemplary embodiment a partial view of a valve in the form of a fuel injector for fuel injection systems of mixture-compressing, externally ignited internal combustion engines. The fuel injector has a tubular valve-seat support 1, which is indicated only schematically and forms part of a valve housing, a longitudinal opening 3 having been formed in valve-seat support 1 in a concentric manner with respect to a longitudinal valve axis 2. Situated in longitudinal opening 3 is a, for example, tubular valve needle 5, which is permanently joined at its downstream end 6 to a, for instance, spherical valve closure member 7 at whose periphery five flattened regions 8, for example, are provided for the fuel to flow past.

The fuel injector may be actuated in a conventional manner, e.g., electromagnetically. A schematically sketched electromagnetic circuit, which includes a magnetic coil 10, an armature 11 and a core 12, is used for axial displacement of valve needle 5, and thus for opening the fuel injector against the spring force of a restoring spring (not shown), or for closing it. Armature 11 is joined to the end of valve needle 5 facing away from valve closure member 7 by a welding seam, which is formed by laser, for instance, and is aligned with core 12.

Using welding, for example, a valve-seat body 16 is mounted in the downstream-lying end of valve-seat support 1 so as to form a seal. At its lower front end 17, facing away from valve-closure member 7, valve-seat body 16 has a stepped design, and a recess 20 is provided in a center region about longitudinal valve axis 2 into which a flat, for instance one-layered orifice plate 23 is placed. Orifice plate 23 has at least one, but ideally two to forty outlet openings 24. An inflow opening 19 is provided in valve-seat body 16 upstream from recess 20, and thus upstream from outlet openings 24 of orifice plate 23, via which the individual outlet openings 24 are approached by the flow. Inflow opening 19 has a larger diameter than the opening width of an exit opening 27 in valve-seat body 16, from which the fuel flows into inflow opening 19 and ultimately into outlet openings 24.

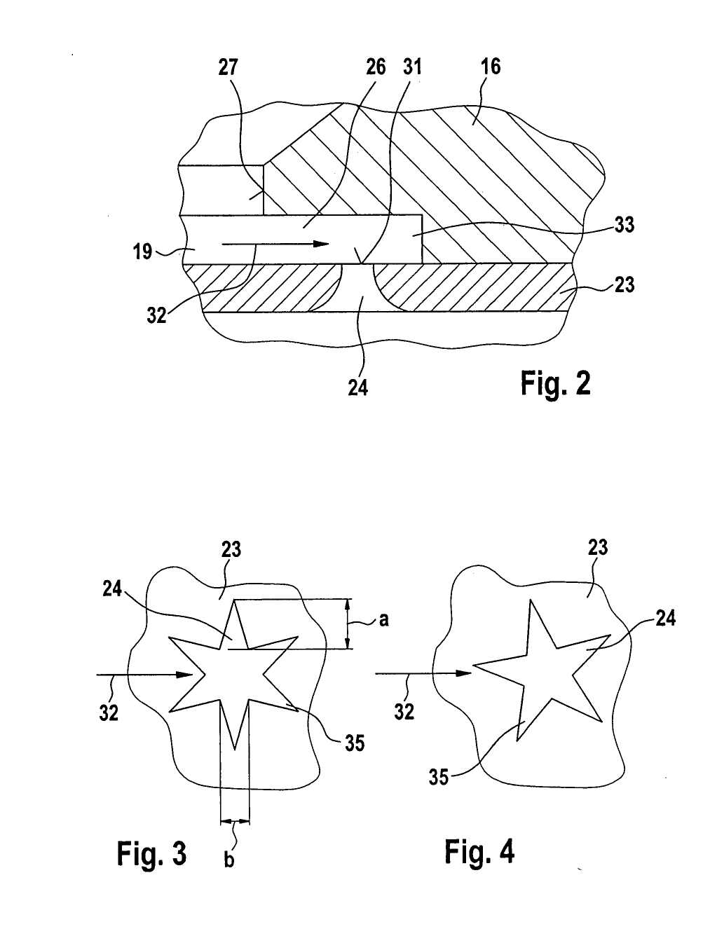

In the immediate inflow region of outlet openings 24, inflow opening 19 is designed such that the flow arrives at outlet openings 24 largely at a right angle to the longitudinal extension of outlet openings 24, i.e., horizontally according to FIG. 1. The annular region of inflow opening 19, which has a larger diameter than exit opening 27, is shown in FIG. 2 in an enlarged view, show in greater detail and denoted by inflow cavity 26 in the following text.

Valve-seat body 16 and orifice plate 23 are connected by, for instance, a circumferential and tight welding seam 25 formed by laser, which is situated outside of inflow opening 19. Once orifice plate 23 has been fixed in place, it is positioned inside recess 20 in a recessed manner relative to end face 17.

The insertion depth of valve-seat body 16 with orifice plate 23 in longitudinal opening 3 defines the magnitude of the lift of valve needle 5 since, given a non-energized magnetic coil 10, one end position of valve needle 5 is defined by the seating of valve closure member 7 on a valve-seat surface 29 of valve-seat body 16, which tapers conically in a downstream direction. When solenoid coil 10 is energized, the other end position of valve needle 5 is defined by the seating of armature 11 on core 12, for instance. The path between these two end positions of valve needle 5 consequently constitutes the lift.

Outlet openings 24 of orifice plate 23 are in direct flow connection with inflow opening 19 and annular inflow cavity 26 and covered by the upper boundary of inflow opening 19. In other words, a complete offset of exit opening 27, which defines the intake of inflow opening 19, and outlet openings 24 is present. The radial offset of outlet openings 24 with respect to exit opening 27 brings about an s-shaped flow pattern of the medium, in this case, the fuel.

The so-called s-twist in front of and within orifice plate 23, with several pronounced flow deflections, imparts a strong, atomization-promoting turbulence to the flow. This causes the velocity gradient transversely to the flow to be particularly pronounced. It is a reflection of the change in the velocity transversely to the flow, the velocity in the center of the flow being markedly greater than in the vicinity of the walls. The higher shear stresses in the fluid resulting from the velocity differences promote the disintegration into fine droplets in close proximity to outlet openings 24. According to the present invention, the atomization of the fluid is further influenced in a positive manner by the specific geometry of outlet openings 24 in connection with inflow cavity 26, which is horizontally approachable by the flow, so that an even better disintegration into the finest droplets is able to be achieved.

Orifice plate 23 is produced by galvanic metal deposition, for instance; particularly advantageous is the production of a one-layer orifice plate 23 utilizing lateral overgrowth technology. Instead of a one-layer orifice plate 23, it is also possible to use an orifice plate 23 having a multi-layer design, in which, for instance, inflow cavity 26 is then integrated directly. Outlet openings 24 ideally have a trumpet-shaped contour. The cross section of outlet openings 24 have a polygonal form, in particular one that encloses at least one triangle, or a meander form with a plurality of curves in the outer contour.

FIG. 2 shows an enlarged cutaway II of FIG. 1 so as to illustrate the geometry of inflow cavity 26 between exit opening 27 and orifice plate 23. Valve-seat body 16 is designed such that, starting with exit opening 27, inflow cavity 26 of inflow opening 19 extends in a very shallow manner above orifice plate 23 in a radially outward direction. Inflow cavity 26 ideally extends beyond outlet opening 24 in a radially outward direction. In this way, above all, each outlet opening 24 is supplied with a considerable portion of the through-flow quantity in the rear as well. Rear space 33 is understood to denote the region of inflow cavity 26 that lies radially outward of the particular outlet opening 24. As a result, the transversal velocity vectors in the outlet of outlet openings 24 are divergent and provide excellent atomization of the fuel.

FIGS. 3 through 9 show seven exemplary embodiments of outlet openings 24 according to the present invention. In an advantageous manner, outlet openings 24 are contoured in such a way that the circumference of outlet opening 24 is maximized in relation to the cross section of outlet opening 24. The cross-sectional form of a fluid jet exiting from an outlet opening 24 largely corresponds to the cross-sectional form of outlet opening 24. The free surface area of a jet exiting an outlet opening 24 is correspondingly large in relation to its spray-discharged fluid quantity. Due to the fact that the flow approaches outlet openings 24 horizontally with respect to entry plane 31 of outlet openings 24, the flow is directionally diffuse in outlet openings 24, i.e., the exiting fluid jet fans out immediately after leaving outlet opening 24. The immediate fanning-out prevents that the surface tension of the fluid contracts the emerging jet into a cylindrical jet having a smaller free surface. The enlarged free jet surface facilitates the further disintegration into smaller droplets.

FIGS. 3 and 4 show two star-shaped outlet openings 24. These outlet openings 24 have, for instance, five spikes 35, each of which has a triangular contour when viewed by itself. The number of spikes 35 and their format as well, i.e., their length a or width b, is freely selectable. Star-shaped outlet opening 24 may either be aligned such that a depression between two spikes 35 points radially directly to longitudinal valve axis 2 or to the center of orifice plate 23 (FIG. 3), or such that a tip of spike 35 points radially directly to longitudinal valve axis 2 or the center of orifice plate 23 (FIG. 4). Arrows 32 indicate on the one hand that the flow approaches outlet openings 24 horizontally with respect to their entry planes 31, or largely at a right angle to the longitudinal extension of outlet openings 24 and, on the other hand, indicate how outlet opening 24 is aligned relative to longitudinal valve axis 2.

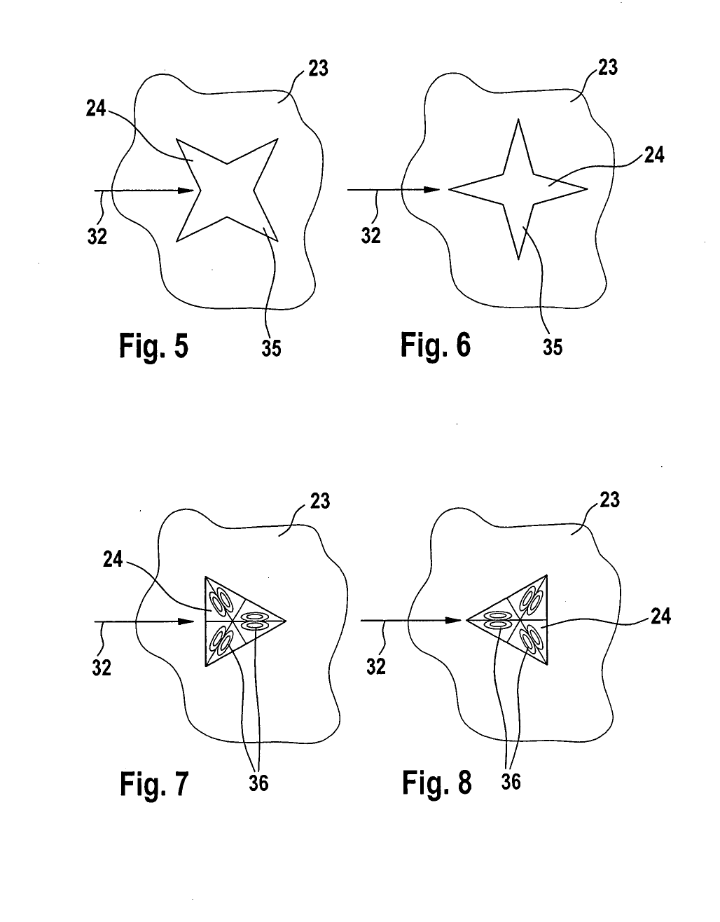

FIGS. 5 and 6 show two star-shaped outlet openings 24. These outlet openings 24 have, for instance, four spikes 35, each of which has a triangular contour when viewed by itself. The number of spikes 35 and their format as well, i.e., their length a or width b, is freely selectable. Star-shaped outlet opening 24 may either be aligned such that a depression between two spikes 35 is radially directly pointing to longitudinal valve axis 2 or to the center of orifice plate 23 (FIG. 5), or such that a tip of spike 35 points radially directly to longitudinal valve axis 2 or to the center of orifice plate 23 (FIG. 6). Arrows 32 indicate on the one hand that the flow approaches outlet openings 24 horizontally with respect to their entry planes 31, or largely at a right angle to the longitudinal extension of outlet openings 24 and, on the other hand, indicate how outlet opening 24 is aligned relative to longitudinal valve axis 2.

FIGS. 7 and 8 show two triangular outlet openings 24. In cross section, outlet opening 24 has the form of an equilateral triangle, for example. Outlet opening 24 is thus considered to be a spike 35. Such a cross-sectional form also facilitates the generation of turbulence in outlet opening 24. The induced turbulence motions induced within outlet opening 24 as a result of the horizontal flow approach are schematically plotted and denoted by reference numeral 36.

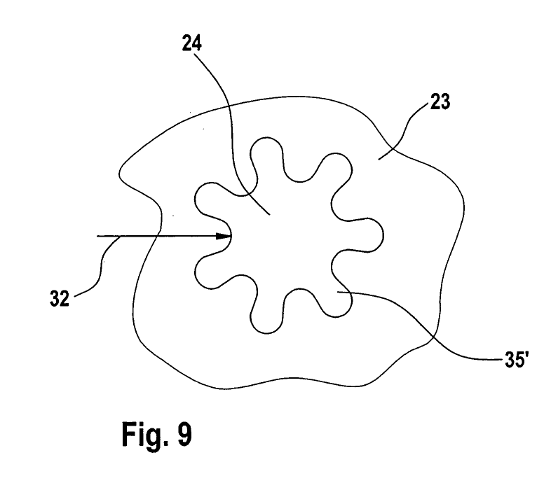

FIG. 9 shows another exemplary embodiment of an outlet opening 24 in cross section. This outlet opening 24 is formed in a meander shape having a plurality of curves 35′ in the outer contour.

Orifice plate 23 may be produced by micro-electroplating, with the aid of laser-cutting technology, etching technology or stamping technology. Depending on the manufacturing process or the intended use, the cross section of outlet openings 24 is constant across the entire length of outlet openings 24, or it increases in the flow direction, as indicated in FIGS. 1 and 2. In the region of entry planes 31 outlet openings 24 have an inner opening width of at least 30 μm, for example.

1-10. (canceled)

11. A fuel injector for a fuel-injection system of an internal combustion engine, the fuel injector having a longitudinal valve axis and comprising:
a valve-seat body having a fixed valve seat;
a valve closure member which cooperates with the valve seat and is axially displaceable along the longitudinal valve axis; and
an orifice plate disposed downstream from the valve seat, the orifice plate having at least one outlet opening, an inflow cavity directly upstream from the at least one outlet opening being configured so that a flow approaches the at least one outlet opening at generally a right angle to a longitudinal extension of the outlet opening;
wherein the at least one outlet opening has one of: i) a polygonal cross section, in a form that encloses at least one triangle, or ii) a meander shaped cross section having a plurality of curves in an outer contour.

12. The fuel injector as recited in claim 11, wherein the inflow cavity is an annular outer region of an inflow opening, which is provided between an exit opening of the valve-seat body and the orifice plate.

13. The fuel injector as recited in claim 12, wherein the exit opening and the at least one outlet opening are completely offset relative to one another.

14. The fuel injector as recited claim 11, wherein the inflow cavity extends in a radially outward direction, beyond the at least one outlet opening, with a rear space.

15. The fuel injector as recited in claim 11, wherein the at least one outlet opening has a form of an equilateral triangle in cross section.

16. The fuel injector as recited in one of claim 11, wherein the at least one outlet opening has a star-shaped cross section.

17. The fuel injector as recited in claim 16, wherein the star-shaped outlet opening has a plurality of triangular spikes.

18. The fuel injector as recited in claim 11, wherein the at least one outlet opening has a trumpet-shaped contour.

19. The fuel injector as recited in claim 11, wherein the orifice plate is produced with using one of galvanic metal deposition, laser-cutting, or stamping technology.

20. The fuel injector as recited in claim 11, wherein between two and forty outlet openings are provided in the orifice plate.
